(19) United States
(12) Patent Application Publication
(10) Pub. No.: US 2014/0057014 A1
(43) Pub. Date: Feb. 27, 2014

(54) Formula Fortifier

(71) Applicants: Carol Lynn Berseth, Evansville, IN (US); Kelly Walsh, Newburgh, IN (US); Deborah Schade, Evansville, IN (US); Ana Cecilia Munoz-Espada, Westerville, OH (US)

(72) Inventors: Carol Lynn Berseth, Evansville, IN (US); Kelly Walsh, Newburgh, IN (US); Deborah Schade, Evansville, IN (US); Ana Cecilia Munoz-Espada, Westerville, OH (US)

(21) Appl. No.: 13/595,296

(22) Filed: Aug. 27, 2012

(51) Int. Cl. A23L 1/29

(52) U.S. Cl. CPC A23L 1/296
USPC 426/2; 426/648; 426/601; 426/73; 426/72

(57) ABSTRACT

The present disclosure provides a premature infant formula fortifier comprising a protein component, a fat component, and a carbohydrate component, wherein about 10 to about 30% of the caloric content of the fortifier is from protein. Also provided is a composition for administration to premature infants, comprising i) a premature infant formula fortifier comprising a protein component, a fat component, and a carbohydrate component, wherein about 10 to about 30% of the caloric content of the fortifier is from protein, and ii) a premature infant formula. Additionally, the present disclosure provides a method for promoting the growth of a premature infant, comprising administering to the infant a composition comprising i) a premature infant formula fortifier comprising a protein component, a fat component, and a carbohydrate component, wherein about 10 to about 30% of the caloric content of the fortifier is from protein, and ii) a premature infant formula.

### TECHNICAL FIELD

The present disclosure relates to premature infant formula fortifiers that are useful for supplementing premature infant formula. The fortifiers described herein are capable of increasing the amounts of certain nutrients of the formula, and are useful in promoting growth in premature infants.

### BACKGROUND

Preterm or premature infants are born prior to the 37^{th} week of gestation and/or weigh less than 2,500 grams at birth. Premature infants include low birth weight (LBW; <2500 g), very low birth weight infants (VLBW; <1500 g), and extremely low birth weight infants (ELBW; <1000 g). Growth rates of preterm infants should ideally meet or exceed intrauterine growth rates in order to facilitate catch-up growth with term infants. Due to their underdeveloped digestive systems and overall developmental immaturity, many preterm infants have special nutritional needs. It is estimated by the European Society for Pediatric Gastroenterology (ESPGHAN) that premature infants should have a protein intake of about 3.5 to 4.5 g/kg/d (3.2 to 4.1 g per 100 kcal) in order to achieve weight gain comparable to in utero rates. Additionally, ESPGHAN recommends a vitamin D intake of 800 to 1000 IU/d in such infants.

Preterm infants are often fed a commercially available premature infant formula or expressed human milk, which is typically supplemented. However, commercially available premature infant formulas generally comprise about 2.8 to about 3.5 g of protein per 100 kcal. Additionally, it is not always possible for a mother to express breast milk after delivery of preterm infants, or to express adequate amounts. Thus, a premature infant formula may be necessary.

Accordingly, there is a need for a composition for the fortification of premature infant formula in order to increase the protein content of the formula while maintaining adequate levels of other nutrients. Such compositions would be useful for supplementing existing premature infant formulas.

### BRIEF SUMMARY

Briefly, the present disclosure is directed to a premature infant formula fortifier comprising a protein component, a fat component, and a carbohydrate component, wherein about 10 to about 30% of the caloric content of the fortifier is from protein. The premature infant formula fortifiers described herein are useful for supplementing the feeding of premature infants, for example while in the hospital and after discharge. More specifically, the fortifiers described herein are capable of increasing the content of certain nutrients in premature infant formula in order to promote the growth of premature infants, such as a very low birth weight infants or extremely low birth weight infants. Nutrients that may be increased with the present fortifiers include, but are not limited to, protein, total calories, vitamin D and fatty acids, such as docosahexaenoic acid.

The present disclosure also relates to a composition for administration to premature infants, comprising i) a premature infant formula fortifier comprising a protein component, a fat component, and a carbohydrate component, wherein about 10 to about 30% of the caloric content of the fortifier is from protein, and ii) a premature infant formula.

Additionally, the present disclosure provides a method for promoting the growth of a premature infant, comprising administering to the infant a composition comprising i) a premature infant formula fortifier comprising a protein component, a fat component, and a carbohydrate component, wherein about 10 to about 30% of the caloric content of the fortifier is from protein, and ii) a premature infant formula. In certain embodiments, the growth rate of the infant will meet or exceed the expected age-specific growth rate of the infant.

### DETAILED DESCRIPTION

Reference now will be made in detail to the embodiments of the present disclosure, one or more examples of which are set forth herein below. Each example is provided by way of explanation of premature infant formula fortifier of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

As used herein, the term “premature infant formula fortifier” refers to a composition useful for supplementing premature infant formula. The premature infant formula fortifier may, in certain embodiments, improve the nutritional content of the premature infant formula with which it is combined. For example, the fortifier may, in certain embodiments, increase the protein content of the premature infant formula. The fortifier also may be formulated to increase other nutrients, including, without limitation, the total caloric content, vitamin D or fatty acids.

“Infant” means a subject having an age of not more than about one year and includes infants from 0 to 12 months. The term infant includes low birth weight infants, very low birth weight infants, and preterm infants. “Preterm” or “premature” means an infant born before the end of the 37^{th} week of gestation or weighing less than 2,500 grams at birth. “Very low birth weight infants” are infants who weigh less than 1,500 grams at birth, while “extremely low birth weight infants” are infants who weigh less than 1,000 grams at birth.

“Failure to thrive” (FTT), a descriptive term and not a definitive clinical diagnosis, is used to describe infants and children whose weight 1) is consistently below the 3rd percentile for their age, 2) progressively decreases to below the 3rd percentile, 3) is 80% of the ideal weight for their height and age, or 4) decreases at an unexpected rate based on the individual's previously defined growth curve, irrespective of whether below the 3rd percentile. FTT may result from a variety of underlying causes, including, but not limited to, decreased nutrient intake caused by cleft lip and/or palate, gastroesophageal reflux, or rumination; malabsorption due to disorders such as celiac disease, cystic fibrosis, or disaccharidase deficiency; impaired metabolism symptomatic of fructose intolerance or classic galactosemia; increased excretion resulting from conditions such as diabetes mellitus and proteinuria; and increased energy requirements of diseases such as bronchopulmonary dysplasia, cystic fibrosis, or hyperthyroidism. Like premature infants, FTT infants have additional nutritional requirements.

“Infant formula” means a composition that satisfies at least a portion of the nutrient requirements of an infant. Infant formula also may be nutritionally complete. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk. A “premature infant formula” is an infant formula designed to meet the particular nutritional needs of premature and low birth weight infants and to promote catch-up growth in such infants. Premature infant formulas include discharge formulas. Enfamil® Premature and Enfamil® Enfacare® are examples of commercially available premature infant and discharge formulas, respectively. In general, premature infant formula have increased calories and protein content compared to infant formula, and may include increased levels of other nutrients as well.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject. An infant formula that is “nutritionally complete” for a preterm infant will provide qualitatively and quantitatively adequate amounts of carbohydrates, lipids, essential fatty acids, proteins, essential amino acids, conditionally essential amino acids, vitamins, minerals, and energy required for growth of the preterm infant.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur, or the body cannot synthesize sufficient amounts.

“Prebiotic” means a non-digestible food ingredient that beneficially affects the host by selectively stimulating the growth and/or activity of one or a limited number of beneficial gut bacteria in the digestive tract, selective reduction in gut pathogens, or favorable influence on gut short chain fatty acid profile that can improve the health of the host.

All percentages, parts and ratios as used herein are by weight of the total formulation, unless otherwise specified.

The present disclosure provides a premature infant formula fortifier, which in certain embodiments, is useful for feeding premature infants, including VLBW or ELBW infants, as well as FTT infants. More particularly, the fortifier described herein is useful for feeding such infants in combination with a premature infant formula.

The premature infant formula fortifier disclosed herein comprises a protein component, a fat component and a carbohydrate component, wherein about 10 to about 30% of the caloric content of the fortifier is from protein. In certain embodiments, about 12 to about 25% of the caloric content of the fortifier is from protein, while in other embodiments, about 14 to about 22% of the caloric content of the fortifier is from protein.

More particularly, in certain embodiments, the fortifier comprises about 0.19 to about 0.56 grams of protein per 7.5 kcal of fortifier. In alternative embodiments, the fortifier comprises about 0.23 to about 0.47 grams of protein per 7.5 kcal, or about 0.27 to about 0.41 grams of protein per 7.5 kcal.

Suitable protein sources include any protein or nitrogen source suitable for infant consumption. For example, the protein source can be any used in the art, e.g., nonfat milk, whey protein, casein, soy protein, hydrolyzed protein, free amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In certain embodiments, the protein source comprises intact, hydrolyzed or partially hydrolyzed proteins, such as hydrolyzed whey protein isolate. If the protein is hydrolyzed, it may be partially hydrolyzed or extensively hydrolyzed. The protein source also may comprises amino acids. The protein source, in some embodiments, may be a combination of intact protein and hydrolyzed protein. When the fortifier comprises a hydrolyzed or partially hydrolyzed protein, the fortifier is appropriate for use with a premature infant formula comprising either intact or hydrolyzed proteins.

In some embodiments, about 20 to about 50% of the caloric content of the premature infant formula fortifier is from fat, while in other embodiments, about 25 to about 45% of the caloric content of the premature infant formula fortifier is from fat. In yet another embodiment, about 30 to about 40% of the caloric content of the premature infant formula fortifier is from fat.

Suitable fat sources useful in the premature infant formula fortifier described herein include but are not limited to, animal sources, e.g., milk fat, butter, butter fat, egg yolk lipid, beef tallow (oleo oil); marine sources, such as fish oils, marine oils, single cell oils; vegetable and plant oils, such as corn oil, canola oil, safflower oil, sunflower oil, soybean oil, palm oil, palm olein oil, coconut oil, babassu oil, tucum oil, cocoa butter, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglycerides (e.g., MCT oil) and other structured lipids such as Betapol® or InFat™, and emulsions and esters of fatty acids; and any combinations thereof. In certain embodiments, the fat source comprises medium chain triglycerides.

In certain embodiments, about 30 to about 60% of the caloric content of the fortifier is from carbohydrates, while in other embodiments, about 35 to about 55% of the caloric content of the fortifier is from carbohydrates. In yet another embodiment, about 42 to about 54% of the caloric content of the fortifier is from carbohydrates.

The carbohydrate source used in the premature infant formula fortifier can be any known in the art. In some embodiments, the carbohydrate source comprises corn syrup solids, maltodextrin, lactose, or a combination thereof. In other embodiments, the carbohydrate source comprises corn syrup solids. Other carbohydrate sources include starches, such as corn, tapioca, rice, or potato, cornstarch, glucose polymers, sucrose, corn syrup, glucose, rice syrup, fructose, high fructose corn syrup, indigestible oligosaccharides, and combinations thereof. The carbohydrate may be hydrolyzed (partially or extensively) or intact and may be non-modified or chemically modified.

In certain embodiments, the premature infant formula fortifier further comprises vitamin D. For example, the fortifier comprises about 50 to about 200 International Units (IU) of vitamin D per 7.5 kcal of the fortifier. In other embodiments, the fortifier comprises about 100 to about 150 IU, or about 110 to about 137 IU of vitamin D per 7.5 kcal of the fortifier. In these embodiments, the fortifier is capable of increasing the vitamin D content of a premature infant formula.

The premature infant formula fortifier may further include a source of long chain polyunsaturated fatty acids (LCPUFA). Suitable LCPUFAs include, but are not limited to, docosahexaenoic acid, α-linoleic acid, γ-linoleic acid, linoleic acid, linolenic acid, eicosapentaenoic acid (EPA) and arachidonic acid (ARA). In certain embodiments, the fortifier comprises DHA, ARA or both. When the fortifier comprises both ARA and DHA, the weight ratio of ARA:DHA may be between about 1:3 and about 9:1. In a particular embodiment, the ratio of ARA:DHA is from about 1:2 to about 4:1.

When included, the amount of DHA may be in a range of about 0.5 to about 10 mg per 7.5 kcal of fortifier. In another embodiment, the amount of DHA ranges from about 1 to about 5 mg per 7.5 kcal of fortifier. The amount of ARA, when present, may be in a range of about 1 to about 10 mg per 7.5 kcal of fortifier, while in another embodiment, the amount of ARA ranges from about 2 to about 5 mg per 7.5 kcal.

The source of DHA and/or ARA may be any source known in the art such as marine oil, fish oil, single cell oil, egg yolk lipid, and brain lipid. In some embodiments, the DHA and ARA are sourced from single cell Martek oils, such as DHASCO® and ARASCO®, or variations thereof. The DHA and ARA can be in natural form, provided that the remainder of the LCPUFA source does not result in any substantial deleterious effect on the subject. Alternatively, the DHA and ARA can be used in refined form.

In an embodiment, sources of DHA and ARA are single cell oils as taught in U.S. Pat. Nos. 5,374,657; 5,550,156; and 5,397,591, the disclosures of which are incorporated herein in their entirety by reference. Nevertheless, the present disclosure is not limited to only such oils.

In some embodiments, the premature infant formula fortifier is acidic. For example, the fortifier may have a pH in a range of about 4.0 to about 4.6. In some embodiments, the pH of the fortifier may be between about 4.1 and 4.5. Most microorganisms exhibit optimal growth in a pH environment above 4.6. While not being bound by any particular theory, it is believed that by providing a premature infant formula fortifier having a pH of less than about 4.6, the growth of many human health pathogens, such as C. botulinum and E. sakazakii, as well as many food spoilage microorganisms may be reduced or prevented. A reduced pH may also prevent the growth of mesophilic and thermophilic spores. Thus, the aforementioned pH ranges reduce the likelihood that microbial growth will occur in the fortifier during shipment and storage.

The fortifier comprises pectin in certain embodiments. The amount of pectin may range from about 40 to about 60 kg of pectin per 10,000 L of the fortifier, in certain embodiments, while in other embodiments, the amount of pectin ranges from about 50 to about 56 kg of pectin per 10,000 L. While not being bound by any particular theory, it is believed that the addition of pectin provides premature infant formula fortifier that is less viscous than the fortifier would be without pectin. Pectin may also assist in the packaging of the fortifier by reducing foaming, creaming or fat separation, and/or sedimentation of minerals and/or protein. This results in a product with a better appearance. For example, the product may appear less curdled and is also more apt to deliver the nutrients contained therein to the infant because the nutrients are better suspended in the product. The nutrients are less likely to settle and/or stick to tubing or bottles. The fortifier may optionally include one or more other anti-foaming agents, such as antifoam 1520 US.

The premature infant formula fortifier described herein is capable of increasing the concentration of certain nutrients of premature infant formula. Accordingly, the premature infant formula fortifier may advantageously be combined with a premature infant formula to provide a composition for administration to premature infants, including very low birth weight (VLBW) and extremely low birth weight (ELBW) infants, as well as FTT infants. For example, in certain embodiments, when the present premature infant formula fortifier is added to a premature infant formula, the resulting composition has an increased protein content. Commercially available premature infant and discharge formulas, such as Enfamil® Premature and Enfamil EnfaCare®, generally comprise about 2.8 to about 3.5 g of protein per 100 kcal. In one embodiment, a fortifier as described herein combined with a premature infant formula provides a composition comprising about 3 to about 5.5 g of protein per 100 kcal. In other embodiments, the resulting composition comprises about 3.2 to about 4.5 g of protein per 100 kcal, while in yet other embodiments the composition comprises about 3.5 to about 4.0 g of protein per 100 kcal.

The total caloric content of a premature infant formula can be increased using the present fortifier, in some embodiments. For example, commercially available premature infant formula generally include about 20 to about 24 kcal per ounce. However, an increased caloric intake may be desirable to promote catch-up growth in premature infants. Thus, upon addition of a fortifier as described herein, the calories of the resulting composition are, in some embodiments, increased to about 22 to about 30 kcal per ounce. In some embodiments, the composition comprises about 23 to about 27 kcal per ounce.

The premature infant formula fortifier comprises between about 5 kcal and about 10 kcal per 5 mL of fortifier, in some embodiments. In other embodiments, the fortifier comprises at least 7.5 kcal per 5 ml fortifier.

In embodiments wherein the fortifier comprises vitamin D, the vitamin D content of a premature infant formula can be increased. For example, in some embodiments, the combination of a fortifier with a premature infant formula results in a composition comprising about 300 to about 1000 IU of vitamin D per 100 kcal, while in other embodiments the composition comprises about 500 to about 800 IU of vitamin D per 100 kcal. In still other embodiments, the composition comprises about 570 to about 670 IU of vitamin D per 100 kcal.

In certain embodiments, the fortifier is combined with the premature infant formula in a ratio of fortifier:formula of between about 1:1 and about 1:10, while in other embodiments, the ratio of fortifier:formula is between about 1:2 and about 1:8, or 1:4 and about 1:6. The skilled artisan can vary the amount of fortifier added to a premature infant formula depending on the particular needs of the infant. Accordingly, about 5 ml of fortifier may be added to between about 10 and about 50 ml of a premature infant formula. Alternatively, about 5 ml of fortifier may be added to between about 20 and about 30 ml of a premature infant formula.

In other embodiments, the fortifier may be administered to an infant separately from, but in combination with, a premature infant formula diet. Thus, about 5 ml of the fortifier may be fed to the infant separately from a premature infant formula feeding. The ratio of fortifier to formula in this embodiment may be between about 1:1 and 1:10, about 1:2 and 1:8, or 1:4 and 1:6.

The present disclosure further provides a method for promoting the growth of a premature infant comprising administering a fortifier as described herein and a premature infant formula. For example, the method may comprise administering a composition comprising a premature infant formula fortifier as described herein and a premature infant formula. In certain embodiments, the growth rate of the premature infant meets or exceeds the expected age-specific growth rate, thereby facilitating catch-up growth. In certain embodiments, the premature infant is a VLBW or ELBW infant. In other embodiments, the infant is an FTT infant.

The premature infant formula fortifier of the present disclosure may be provided in any form known in the art, such as a powder, a gel, a suspension, a paste, a solid, a liquid, a liquid concentrate, a reconstitutable powdered milk substitute or a ready-to-use product. In certain embodiments, the fortifier is provided as a sterile liquid and conveniently packaged in individual servings. Numerous types of packaging and containers are available and known in the art. For example, the fortifier may be packaged in packets or sachets manufactured from paper, foil, plastic, or foil and plastic coated paper, and ampoules made from plastic, paper or glass. In a particular embodiment, the fortifier is filled into a form or blow-fill-seal package and sealed in an environment that prevents recontamination of the product with microorganisms. In this embodiment, a container is formed, filled with the fortifier, and sealed in a continuous process without human intervention in an enclosed area designed and operated to minimize the probability of contamination with microorganisms. Such a package may be a unit dose of the fortifier. Thus, the package may contain about 5 ml of the fortifier, which is designed to be directly added to a premature infant formula.

To avoid the dilution of nutrients, the fortifier, in certain embodiments, comprises additional nutrients that are conventionally found in premature infant formula, including vitamins, minerals, nucleotides and fatty acids. The additional nutrients may be in quantities appropriate to maintain the concentrations in the premature infant formula, or to increase the concentrations of select nutrients, if desired. Vitamins that may be employed in the present invention include, for example, vitamin A, vitamin D, vitamin E, vitamin K₁, thiamin, riboflavin, vitamin B₆, vitamin B₁₂, niacin, folic acid, pantothenic acid, biotin, and vitamin C. Mineral nutrients that may be added include, for example, calcium, phosphorus, magnesium, zinc, manganese, copper, sodium, potassium, chloride, iron, selenium, chromium, and molybdenum. More specifically, the fortifier may optionally include one or more of the following vitamins or derivations thereof: vitamin B₁ (thiamin, thiamin pyrophosphate, thiamin triphosphate, thiamin hydrochloride, thiamin mononitrate), vitamin B₂ (riboflavin, flavin mononucleotide, flavin adenine dinucleotide, lactoflavin, ovoflavin), vitamin B₃ (niacin, nicotinic acid, nicotinamide, niacinamide, nicotinamide adenine dinucleotide, nicotinic acid mononucleotide, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamine, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof. Additional vitamins and minerals that can be added are within the knowledge of a person with ordinary skill in the art who can determine the appropriate amount of vitamins and mineral nutrients following the recommendations of the Committee on Nutrition of the American Academy of Pediatrics or other groups of experts, such as ESPGHAN.

The premature infant formula fortifier may also contain one or more prebiotics in certain embodiments. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide (also called oligofructose), isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides.

In an embodiment, the total amount of prebiotics present in the fortifier may be from about 1.0 g/L to about 10.0 g/L of the composition. At least 20% of the prebiotics can comprise galacto-oligosaccharide, polydextrose or a mixture thereof. The amount of each of galacto-oligosaccharide and/or polydextrose in the fortifier may, in an embodiment, be within the range of from about 1.0 g/L to about 4.0 g/L.

In an embodiment, a fortifier of the present disclosure comprises choline. Choline is a nutrient that is essential for normal function of cells. It is a precursor for membrane phospholipids, and it accelerates the synthesis and release of acetylcholine, a neurotransmitter involved in memory storage. Moreover, though not wishing to be bound by this or any other theory, it is believed that dietary choline and DHA act synergistically to promote the biosynthesis of phosphatidylcholine and thus help promote synaptogenesis in human subjects. Additionally, choline and DHA may exhibit the synergistic effect of promoting dendritic spine formation, which is important in the maintenance of established synaptic connections. In some embodiments, the nutritional composition(s) of the present disclosure includes about 40 mg choline per serving to about 100 mg per 8 oz. serving.

In an embodiment, a fortifier described herein comprises a source of iron. In an embodiment, the source of iron is ferric pyrophosphate, ferric orthophosphate, ferrous fumarate or a mixture thereof and the source of iron may be encapsulated in some embodiments.

The premature infant formula fortifier of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The fortifier of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The fortifier of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, sodium carboxymethylcellulose, methylcellulose hydroxypropyl methyl cellulose, hydroxypropyl cellulose, diacetyl tartaric acid esters of mono- and diglycerides, dextran, carrageenans, and mixtures thereof.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified in any range. Any reference to a range should be considered as providing support for any subset within that range.

Examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the examples.

### EXAMPLES

### Example 1

Table 1 describes an example of the caloric distribution of macronutrients in a premature infant formula (Enfamil® Premature) with and without a fortifier of the present disclosure. The fortifier is added to Enfamil® Premature high protein in an amount sufficient to increase the amount of protein from 3.5 g/100 kcal to 4.0 g/100 kcal.

TABLE 1
Caloric distribution of macronutrients.

| | | Enfamil ® | | Enfamil ® |
|---|---|---|---|---|
| | Enfamil ® | Premature | Premature | Premature |
| | Premature | high protein | infant | high |
| | (3.0 g protein | (3.5 g protein | formula | protein + |
| % of kcal | per 100 kcal | per100 kcal | fortifier | fortifier |
| Protein | 12 | 14 | 22 | 16 |
| Fat | 44 | 43 | 36 | 42 |
| Carbohydrate | 44 | 43 | 42 | 42 |

### Example 2

Table 2 describes the nutrient profile of a fortifier in accordance with the present disclosure and a composition of a premature infant formula (Enfamil® Premature high protein) and the fortifier.

TABLE 2
Example nutrient profile.

| | | | 100 mL |
|---|---|---|---|
| | | Premature | Premature |
| | | formula fortifier | formula (3.5 g |
| | | (1 vial = 7.5 kcal; | per 100 kcal |
| | | 5 mL) | protein + 4 vials) |
| nutrient | UOM | UOM/7.5 kcal | UOM/100 kcal |
| Biotin | mcg | 0.31 | 4 |
| C18:2n6 Linoleic acid | mg | 60 | 810 |
| C18:3n3 α-linolenic | mg | 6.7 | 90 |
| C20:4n6 Arachidonic acid | mg | 2.4 | 34 |
| C22:6n3 Docosahexaenoic | mg | 1.27-10.7 | 17-51 |
| acid | | | |
| Carbohydrates | g | 0.65-0.79 | 10-10.5 |
| Carnitine | mg | 0.12 | 2.2 |
| Choline | mg | 1.5 | 20 |
| Fat | g | 0.31 | 5.1 |
| Folic acid | mcg | 2.6 | 40 |
| Inositol | mg | 3.2 | 44 |
| Calcium | mg | 12.3 | 165 |
| Chloride | mg | 8.1 | 95 |
| Copper | mcg | 7.7 | 115 |
| Iron | mg | 0.13 | 1.8 |
| Iodine | mcg | 1.94 | 25 |
| Potassium | mg | 5 | 90 |
| Magnesium | mg | 0.67 | 9 |
| Manganese | mcg | 0.47 | 6.3 |
| Sodium | mg | 5.7 | 63 |
| Phosphorus | mg | 6.3 | 83 |
| Selenium | mcg | 0.2 | 2.8 |
| Zinc | mg | 0.11 | 1.5 |
| Niacin NE (vitamin B₃) | mcg | 230 | 3700 |
| Adenosine | mg | 0.04 | 0.5 |
| 5′-monophosphate | | | |
| Cytidine 5′-monophosphate | mg | 0.19 | 2.5 |
| Guanosine | mg | 0.02 | 0.3 |
| 5′-monophosphate | | | |
| Uridine 5′-monophosphate | mg | 0.07 | 0.9 |
| Pantothenic acid | mcg | 91 | 1200 |
| Protein | g | 0.27-0.41 | 3.5-4 |
| Taurine | mg | 0.44 | 6 |
| Vitamin A | IU | 94 | 1250 |
| Vitamin B₁ (thiamin) | mcg | 10.8 | 185 |
| Vitamin B₁₂ (cobalamine) | mcg | 0.01 | 0.23 |
| Vitamin B₂ (riboflavin) | mcg | 16.3 | 275 |
| Vitamin B₆ (pyridoxine) | mcg | 11.1 | 150 |
| Vitamin C | mg | 0.95 | 18 |
| Vitamin D (calciferol) | IU | 110-137 | 570-670 |
| Vitamin E | IU | 0.47 | 6.3 |
| Vitamin K | mcg | 0.67 | 9 |
| Total nucleotides | mg | 0.32 | 4.2 |

### Example 3

This example lists the ingredients in an exemplary premature infant formula fortifier.

TABLE 3
Exemplary fortifier ingredients (10,000 L)

| Kg/10,000 L | Ingredient |
|---|---|
| 7530 | De-fluoride water |
| 0-1680 | Corn syrup solids |
| 0-1680 | Maltodextrin |
| 0-1680 | Lactose |
| 830-925 | Whey protein isolate (hydrolyzed) |
| 365 | Soy oil |
| 242 | Medium chain triglyceride oil |
| 105.012 | Citric acid |
| 53.781 | Pectin |
| 35 | Calcium phosphate |
| 29 | Calcium chloride |
| 20.5 | Calcium citrate |
| 19 | Calcium phosphate |
| 18.8 | Fungal-algal (2:1) oil blend |
| 0-6.3 | Fungal ARA oil |
| 9 | Magnesium phosphate |
| 8 | Potassium citrate |
| 4.32 | Choline chloride |
| 1.43 | Ferrous sulfate |
| 0.8 | Sodium chloride |
| 0.466 | Antifoam 1520-US |
| 0.35 | Sodium citrate |
| 0.035 | Oil single cell 40% DHA |
| 0.27 | L-carnitine |

The formulation of example 3 can further include additional vitamins, minerals and nucleotides, for example, those typically used in infant formula.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the versions contained therein.

What is claimed is:

1. A premature infant formula fortifier comprising:
a protein component,
a fat component, and
a carbohydrate component,
wherein about 10 to about 30% of the caloric content of the fortifier is from protein.

2. The premature infant formula fortifier of claim 1, wherein about 12 to about 25% of the caloric content of the fortifier is from protein.

3. The premature infant formula fortifier of claim 1, wherein the protein component comprises a hydrolyzed protein or a partially hydrolyzed protein.

4. The premature infant formula fortifier of claim 1, wherein the protein component comprises a hydrolyzed whey protein isolate.

5. The premature infant formula fortifier of claim 1, wherein about 25 to about 50% of the caloric content of the fortifier is from fat.

6. The premature infant formula fortifier of claim 1, wherein the fat component comprises medium chain triglycerides.

7. The premature infant formula fortifier of claim 1, wherein about 30 to about 60% of the caloric content of the fortifier is from carbohydrates.

8. The premature infant formula fortifier of claim 1, further comprising about 50 to about 200 international Units (IU) of vitamin D per 7.5 kcal of the fortifier.

9. The premature infant formula fortifier of claim 1, further comprising a source of long chain polyunsaturated fatty acids (LCPUFA).

10. The premature infant formula fortifier of claim 1, wherein the fortifier has a pH of 4.6 or less.

11. The premature infant formula fortifier of claim 1, further comprising pectin.

12. The premature infant formula fortifier of claim 1, further comprising vitamins and minerals.

13. The premature infant formula fortifier of claim 1, wherein the premature infant fortifier is for use in a very low birth weight (VLBW) infant or an extremely low birth weight (ELBW) infant.

14. A composition for administration to premature infants comprising:
i) a premature infant formula fortifier comprising:
a protein component,
a fat component, and
a carbohydrate component,
wherein about 10 to about 30% of the caloric content of the fortifier is from protein; and
ii) a premature infant formula.

15. The composition of claim 14, wherein the composition comprises about 3 to about 5.5 g of protein per 100 kcal of the composition.

16. The composition of claim 14, wherein the composition comprises about 22 to about 30 kcal per ounce.

17. The composition of claim 14, wherein the composition comprises about 300 to 1000 IU of vitamin D.

18. The composition of claim 14, wherein the volume ratio of premature infant formula fortifier to premature infant formula is in a range of about 1:2 to about 1:10.

19. The composition of claim 14, wherein the volume ratio of premature infant formula fortifier to premature infant formula is in a range of about 1:4 to about 1:5.

20. A method for promoting growth of a premature infant comprising administering to the infant a composition comprising:
i) a premature infant formula fortifier comprising:
a protein component,
a fat component, and
a carbohydrate component,
wherein about 10 to about 30% of the caloric content of the fortifier is from protein; and
ii) a premature infant formula.
